(19) United States
(12) Patent Application Publication
(10) Pub. No.: US 2023/0137663 A1
(43) Pub. Date: May 4, 2023

(54) MODEM FOR VEHICLE, APPARATUS AND METHOD FOR PROCESSING SERVICE REQUEST THEREFOR

(71) Applicants: HYUNDAI MOTOR COMPANY, Seoul (KR); KIA CORPORATION, Seoul (KR)

(72) Inventor: Sang Min LEE, Suwon-si (KR)

(73) Assignees: HYUNDAI MOTOR COMPANY, Seoul (KR); KIA CORPORATION, Seoul (KR)

(21) Appl. No.: 17/892,464

(22) Filed: Aug. 22, 2022

(30) Foreign Application Priority Data
Nov. 3, 2021 (KR) 10-2021-0150016

(51) Int. Cl. H04W 4/90; H04W 4/40

(52) U.S. Cl. CPC H04W 4/90; H04W 4/40

(57) ABSTRACT

A service request processing apparatus for a modem for a vehicle according to an embodiment of present disclosure includes a receiver, a management device, a service request processor, and a transmitter. The receiver receives emergency call state information generated based on a connection state of an emergency call service of a vehicle, and a service request for attempting a communication connection to the vehicle from a sender. The management device updates the emergency call state information in storage. The service request processor retrieves the emergency call state information in the storage in response to the service request, and determines whether to transmit the service request to the vehicle based on the emergency call state information. The transmitter transmits the service request to the vehicle under a control of the service request processor.

### CROSS-REFERENCE TO RELATED APPLICATION

This application claims the benefit of priority to Korean Patent Application No. 10-2021-0150016, filed in the Korean Intellectual Property Office on Nov. 03, 2021, the entire contents of which are incorporated herein by reference.

### TECHNICAL FIELD

The present disclosure relates to a modem for a vehicle, an apparatus and a method for processing service request therefor.

### BACKGROUND

For safety or emergency situations, an emergency call (eCall) system applied to vehicles is being established. In addition, for user convenience, the use of a connected service that remotely controls vehicles is increasing.

The emergency call service and the connected service are performed based on communication connection using a modem installed in the vehicle. Conventionally, a modem for the emergency call service and a modem for the connected service are separately installed in vehicles, but in order to reduce manufacturing cost and size, a method of performing the emergency call service and the connected service using an integrated modem is being used.

Since a modem integrated into one may maintain only one communication channel, a technique for processing a call signal attempting a communication request depending on the situation is becoming important.

### SUMMARY

The present disclosure has been made to solve the above-mentioned problems occurring in the related art while maintaining the advantages achieved by the related art.

An embodiment of the present disclosure is to provide a modem for a vehicle capable of stably maintaining a communication channel according to importance, and a service request processing apparatus and method therefor.

An embodiment of the present disclosure is to provide a modem for a vehicle capable of stably maintaining an emergency call by reducing battery consumption of a vehicle, and a service request processing apparatus and method therefor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a service request processing apparatus for a modem for a vehicle includes a receiver, a management device, a service request processor, and a transmitter. The receiver receives emergency call state information generated based on a connection state of an emergency call service of a vehicle, and a service request for attempting a communication connection to the vehicle from a sender. The management device updates the emergency call state information in storage. The service request processor retrieves the emergency call state information in the storage in response to the service request, and determines whether to transmit the service request to the vehicle based on the emergency call state information. The transmitter transmits the service request to the vehicle under a control of the service request processor.

In an embodiment, the transmitter may transmit the service request to the modem in the vehicle, which connects the emergency call service.

In an embodiment, the transmitter may transmit a connected service request for attempting remote control of the vehicle as the service request.

In an embodiment, the management device may update the emergency call state information to the storage by designating any one of an end state, an operation state, and a callback state.

In an embodiment, the service request processor may transmit the service request to the vehicle through the transmitter, based on whether the emergency call state information is the end state or the callback state.

In an embodiment, the service request processor may transmit, to the sender, information informing of refraining from requesting a service, based on the emergency call state information being the callback state.

In an embodiment, the service request processor may reject the service request based on the emergency call state information being the operation state.

According to an aspect of the present disclosure, a service request processing method for a modem for a vehicle includes updating, by a management device, an emergency call state information generated based on a connection state of an emergency call service of the vehicle, identifying, by a server, the emergency call state information in response to a service request for attempting a communication connection from a sender to the vehicle, and determining, by a service request processor, whether to transmit the service request to the modem based on the emergency call state information.

In an embodiment, the identifying of the emergency call state information may further include identifying, by the server, whether the service request is a signal for calling the modem in the vehicle, which connects the emergency call service.

In an embodiment, the identifying of the emergency call state information may further include identifying, by the server, whether the service request is a connected service request for attempting remote control of the vehicle.

In an embodiment, the updating of the emergency call state information may include updating, by the management device, the emergency call state information by designating any one of an end state, an operation state, and a callback state.

In an embodiment, the determining of the whether to transmit the service request may include transmitting, by the service request processor, the service request to the vehicle, based on whether the emergency call state information is the end state or the callback state.

In an embodiment, the determining of the whether to transmit the service request may include transmitting, by the service request processor, to the sender, information informing of refraining from requesting a service, based on the emergency call state information being the callback state.

In an embodiment, the determining of the whether to transmit the service request may include rejecting by the service request processor, a transmission of the service request based on the emergency call state information being the operation state.

According to an aspect of the present disclosure, a modem for a vehicle includes a modem controller that generates emergency call state information based on a connection state of an emergency call, a transmission interface that transmits the emergency call to an external emergency center and to transmit the emergency call state information to an external server, and a reception interface that receives the emergency call and receives a service request for the vehicle.

In an embodiment, the reception interface may receive a connected service request for attempting remote control of the vehicle as the service request.

In an embodiment, the modem controller may set the emergency call state information in a state in which the emergency call is not transmitted to an end state.

In an embodiment, the modem controller may set the emergency call state information of a state in which communication with the emergency center is connected to an operation state based on the transmission of the emergency call.

In an embodiment, the modem controller may set the emergency call state information in a state in which the emergency call is sent within a specific time and communication with the emergency center is not connected to a callback state.

In an embodiment, the modem controller may further provide the service request received while the emergency call state information is in an end state or a callback state to a control device of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram schematically illustrating a service request processing procedure according to an embodiment of the present disclosure;

FIG. 2 is a block diagram illustrating a configuration of a service request processing system according to an embodiment of the present disclosure;

FIG. 3 is a flowchart illustrating an embodiment in which a modem controller generates emergency call state information;

FIG. 4 is a flowchart illustrating a service request processing procedure according to an embodiment of the present disclosure;

FIG. 5 is a diagram describing a service request processing procedure according to an embodiment of the present disclosure in more details; and

FIG. 6 is a diagram illustrating a computing system according to an embodiment of the present disclosure.

### DETAILED DESCRIPTION

Hereinafter, some embodiments of the present disclosure will be described in detail with reference to the drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it may interfere with the understanding of the embodiment of the present disclosure.

In describing the components of the embodiment according to the present disclosure, terms such as “first,” “second,” “A,” “B,” “(a),” “(b),” and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

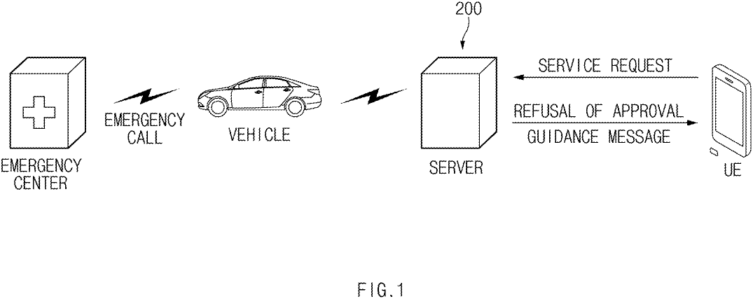

Hereinafter, embodiments of the present disclosure will be described in detail with reference to FIGS. 1 to 6.

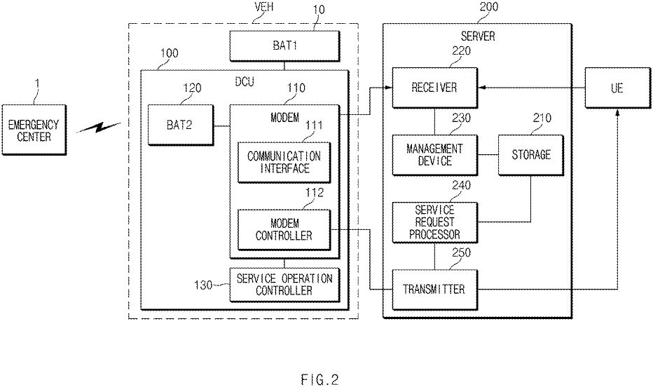

FIG. 1 is a diagram schematically illustrating a service request processing procedure according to an embodiment of the present disclosure, and FIG. 2 is a block diagram illustrating a configuration of a service request processing system according to an embodiment of the present disclosure.

Referring to FIGS. 1 and 2, a service request processing system according to an embodiment of the present disclosure may include a vehicle VEH and a server 200.

The vehicle VEH may connect an emergency call (ecall) to an emergency center 1, and may receive a service request from a sender UE through the server 200. The emergency center 1 may include an emergency rescue organization, an emergency rescue support organization, and other support organizations. The emergency rescue organization may include the fire and disaster prevention agency, the fire department, and the fire station. The emergency rescue support organization may include police stations and emergency medical institutions. Other support organizations may include traffic management centers and towing companies. The sender UE may be a user terminal, or another server or service center that is distinct from the server 200 for service request processing. Hereinafter, the present specification will be mainly described with reference to the user terminal UE. The user terminal UE may be a portable user terminal including a cellular phone, a smart phone, a tablet PC, a notebook computer, a wearable terminal, and the like.

The server 200 may identify emergency call state information of the vehicle VEH, and may determine whether to transmit a service request from the user terminal UE to the vehicle VEH based on the emergency call state information.

The vehicle VEH and the server 200 according to an embodiment of the present disclosure will be described in more detail below.

The vehicle VEH according to an embodiment of the present disclosure may include a first battery 10 and a vehicle control apparatus 100.

The first battery 10 is a vehicle battery and may be a removable battery. The first battery 10 may provide power to a modem 110, and may also provide power to a driving device and an infotainment device of a vehicle.

The vehicle control apparatus 100 may be integrally formed with vehicle’s internal control units, or may be implemented as a separate device and connected to vehicle’s control units by a separate connection means. The vehicle control apparatus 100 may be implemented as domain control units (DCUs) in which a central gateway is added to an electronic control unit (ECU) .

The vehicle control apparatus 100 may include the modem 110, a second battery 120, and a service operation controller 130.

The modem 110 may modulate and transmit a digital signal into an analog signal, and may demodulate a received analog signal into a digital signal to communicate with the emergency center 1 or the server 200. The modem 110 may include a communication interface 111 and a modem controller 112.

The communication interface 111 may communicate with the emergency center 1 or the server 200 through a wireless communication protocol. The communication interface 111 may transmit/receive a radio signal using a mobile communication network constructed based on a GSM (Global System for Mobile communication), a CDMA (Code Division MultiAccess), a CDMA2000 (Code Division Multi Access 2000), an EV-DO (Enhanced Voice-Data Optimized or Enhanced Voice-DataOnly), a WCDMA (Wideband) CDMA), a HSDPA (High Speed Downlink Packet Access), a HSUPA (High Speed Uplink Packet Access), an LTE (Long Term Evolution), an LTE-A (Long Term Evolution-Advanced), etc.

The communication interface 111 may include a reception interface and a transmission interface. The reception interface may receive an emergency call and receive a service request for the vehicle. The transmission interface may transmit an emergency call to the external emergency center 1 and may transmit the emergency call state information generated based on a connection state of the emergency call to an external server.

The modem controller 112 may control the overall operation of the modem 110. The modem controller 112 may control the transmission interface and the reception interface, and may transmit a received service request to the service operation controller 130.

The modem controller 112 may generate the emergency call state information based on the connection state of the emergency call. The emergency call may mean a call signal transmitted to the emergency center 1 through the modem 110 when an emergency of the vehicle VEH occurs. The modem 110 may transmit the emergency call by a user’s manipulation, or may transmit the emergency call based on detecting the occurrence of an accident. When the modem 110 and the emergency center 1 are wirelessly connected through the emergency call, the modem 110 may provide a vehicle ID and vehicle’s driver information to the emergency center 1.

The modem controller 112 may generate the emergency call state information divided into an end state, an operation state, and a callback state, based on whether an emergency call is sent and a communication connection state between the modem 110 and the emergency center 1.

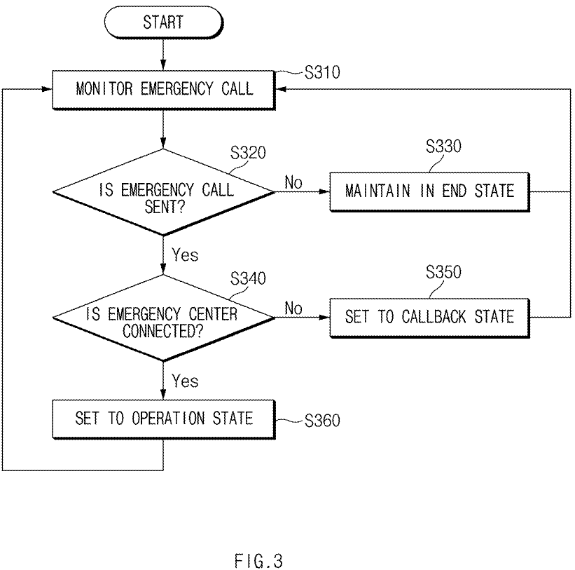

FIG. 3 is a flowchart illustrating an embodiment in which the modem controller 112 generates emergency call state information. FIG. 3 illustrates an embodiment in which emergency call monitoring is performed from a time when the emergency call is in the end state. The modem controller 112 may set the emergency call state information to the end state when the emergency call is not transmitted while the communication between the modem 110 and the emergency center 1 is not connected.

Referring to FIG. 3, the modem controller 112 may monitor whether the emergency call is sent in real time (S310, and S320) .

The modem controller 112 may maintain the emergency call state information in the end state in a state in which the emergency call is not sent (S330).

When a sending of the emergency call is detected, the modem controller 112 may determine whether communication is connected between the modem 110 and the emergency center 1 (S340) .

When the emergency call is sent, but communication connection is not established between the modem 110 and the emergency center 1, the modem controller 112 may set the emergency call state information to the callback state (S350). When the emergency center 1 cannot receive or the vehicle VEH is in a shaded area, the emergency call from the modem 110 may not be connected to the emergency center 1. When the emergency call from the modem 110 is not connected, the modem 110 may be in a state of waiting for a callback from the emergency center 1.

When a communication connection is established between the modem 110 and the emergency center 1 by sending the emergency call, the modem controller 112 may set the emergency call state information to the operation state (S360).

When a service request for the vehicle VEH is received, the service operation controller 130 may control an operation corresponding to the service request.

The service request for the vehicle VEH may be a call signal that calls the modem 110, for example, may be a connected service request requested through the server 200. The connected service request may be a request for attempting to remotely control the vehicle VEH. For example, the connected service request may be a request for opening a door of the vehicle VEH or controlling the ignition of the vehicle. In addition, the connected service request may be a request for remote update of a navigation device or for remotely controlling an infotainment device of a vehicle.

The service operation controller 130 may be connected to the modem 110 by wire or wirelessly.

The second battery 120 may be an emergency battery mounted on the vehicle control apparatus 100 and used when the first battery 10 is in a removed or discharged state.

The server 200 according to an embodiment of the present disclosure may include a service request processing apparatus according to an embodiment of the present disclosure.

The server 200 may include storage 210, a receiver 220, a management device 230, a service request processor 240, and a transmitter 250.

The receiver 220 may receive emergency call state information to the vehicle, and may receive a service request for the vehicle VEH from the user terminal UE.

The management device 230 may update the emergency call state information in the storage 210.

The service request processor 240 may retrieve the emergency call state information stored in the storage 210 in response to the service request. The service request processor 240 may determine whether to transmit the service request to the vehicle VEH based on the emergency call state information.

The transmitter 250 may transmit the service request to the vehicle VEH under the control of the service request processor 240.

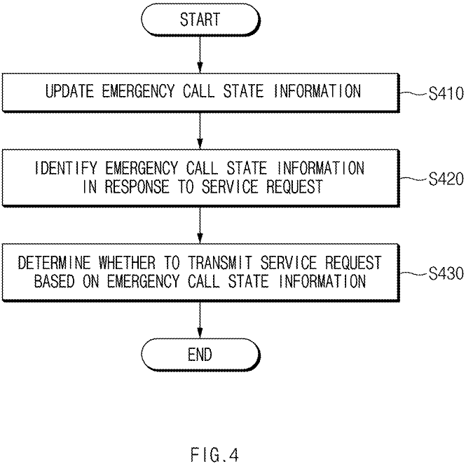

FIG. 4 is a flowchart illustrating a service request processing procedure according to an embodiment of the present disclosure. A service request processing procedure illustrated in FIG. 4 may be processed by the server 200 outside the vehicle VEH.

Referring to FIG. 4, in the service request processing procedure according to an embodiment of the present disclosure, in a first operation (S410), the server 200 may update the emergency call state information.

The server 200 may receive the emergency call state information divided into the end state, the operation state, and the callback state from the vehicle VEH, and may store the received emergency call state information in the storage 210. Each emergency call state information may be stored in the storage 210 as a preset binary code. For example, the end state may be set to a binary code ‘00’, the operation state may be set to a binary code ‘01’ and the callback state may be set to a binary code ‘10’.

In a second operation (S420), the server 200 may identify the emergency call state information in response to the service request. The operation of identifying the emergency call state information may include determining whether the service request is a signal for calling the modem. In addition, the operation of identifying the emergency call state information may include a procedure of identifying that the service request is the connected service request that attempts to remotely control the vehicle. Upon receiving the service request from the vehicle VEH, the server 200 may retrieve the storage 210 to identify the emergency call state information at the time the service request is received.

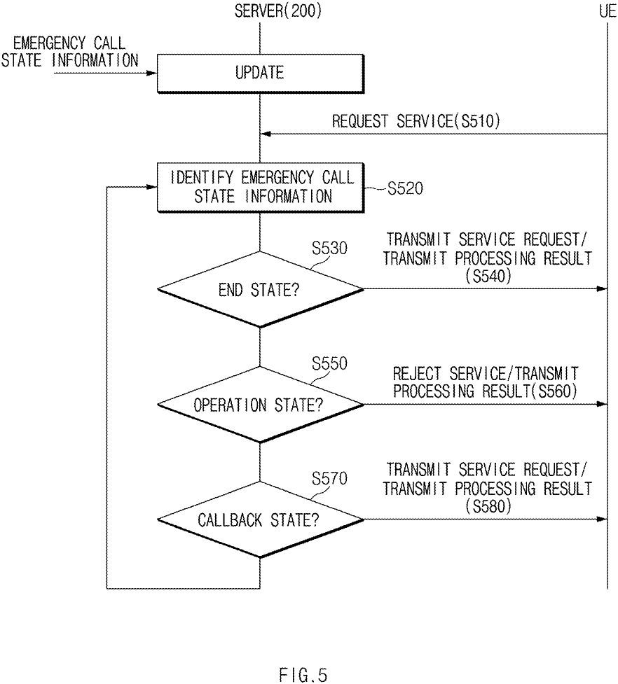

In a third operation (S430), the server 200 may determine whether to transmit the service request based on the emergency call state information. An embodiment of determining whether to transmit the service request according to the emergency call state information will be described later with reference to FIG. 5.

FIG. 5 is a diagram describing a service request processing procedure according to an embodiment of the present disclosure in more detail.

Referring to FIG. 5, the server 200 may update the emergency call state information provided in real time from the vehicle VEH (S500). The modem 110 of the vehicle VEH may transmit the emergency call state information to the server 200 whenever the emergency call state information changes. The receiver 220 of the server 200 may receive the emergency call state information from the vehicle VEH, and the management device 230 of the server 200 may store the received emergency call state information in the storage 210.

The server 200 may identify the emergency call state information in response to the service request (S510 and S520). The service request may be a call signal that attempts a communication connection to the modem 110 of the vehicle VEH. For example, the service request may be a connected service request called from the user terminal UE. Alternatively, the service request may be a connected service request called from a connected service center or the like. Upon receiving the service request, the service request processor 240 of the server 200 may retrieve the storage 210 to identify the emergency call state information.

Based on that the emergency call state information is the end state, the server 200 may transfer the service request and transmit a processing result (S530 and S540). The emergency call state information that is the end state may mean that the modem 110 of the vehicle VEH does not communicate with the emergency center 1 and does not intend to receive a call signal from the emergency center 1. Accordingly, when the emergency call state information is the end state, the service request processor 240 may transmit the service request to the modem 110 of the vehicle VEH through the transmitter 250. In addition, the service request processor 240 may transmit the processing result of transmitting the service request to the modem 110 of the vehicle VEH to the service request sender through the transmitter 250.

Alternatively, based on that the emergency call state information is the operation state, the server 200 may reject the service request and may transmit the processing result to the user terminal UE (S550 and S560). The emergency call state information that is the operation state may mean that the modem 110 of the vehicle VEH is in a communication connection state with the emergency center 1. The modem 110 of the vehicle VEH needs to maintain an emergency call connection as a top priority. Accordingly, when the emergency call state information is in the operation state, the service request processor 240 may not transmit the service request to the modem 110 of the vehicle VEH. In addition, the service request processor 240 may transmit a processing result indicating that the corresponding service is rejected to the user terminal UE through the transmitter 250.

When the vehicle is in the emergency call connection state, since the server 200 rejects the service request before transferring the service request to the vehicle VEH, the service request may be processed more quickly. Accordingly, the sender of the service request may know the service request processing result more quickly.

In addition, since there is no need to receive the service request or process the service request in the emergency call connection state, the modem 110 of the vehicle VEH may stably maintain the emergency call connection state.

In addition, since the modem 110 of the vehicle VEH does not receive unnecessary service requests, unnecessary power consumption may be prevented, thereby helping to stably maintain a power state in an emergency situation. When the service request continues to the vehicle VEH during the emergency call connection state, the battery power of the vehicle VEH may be unnecessarily consumed. When the charge amount of the first battery 10, which is a vehicle battery, is low, or when the first battery 10 is removed due to an accident, the modem 110 should use the second battery 120 mounted in the vehicle control apparatus 100. Since the second battery 120 corresponds to an auxiliary voltage source with a small amount of power, the battery may be discharged due to unnecessary power consumption. For example, when the connected service request such as vehicle location check continues, the modem 110 may repeatedly boot and sleep, resulting in power consumption of the second battery 120. According to an embodiment of the present disclosure, since an additional emergency call is highly likely to occur in the emergency call connection state, the communication connection attempt to the modem 110 of the vehicle VEH may be blocked in advance in order to waste battery power of the vehicle VEH.

Based on that the emergency call state information is the operation state, the server 200 may approve the service request and may transmit the processing result to the user terminal UE (S570 and S580). The emergency call state information having the callback state may mean a waiting state in which a communication request should be received from the emergency center 1, although communication is not connected between the modem 110 of the vehicle VEH and the emergency center 1. That is, since the callback state does not mean that the modem 110 maintains a connection state with the emergency center 1, the service request processor 240 may transmit a service request to the modem 110 of the vehicle VEH when the emergency call state information is the callback state. In addition, the service request processor 240 may transmit the service request processing result to the service request sender through the transmitter 250. In addition, to prevent unnecessary battery consumption even in the callback state, information indicating the callback state of an emergency call may be included in the service request processing result to induce refraining from additional service requests.

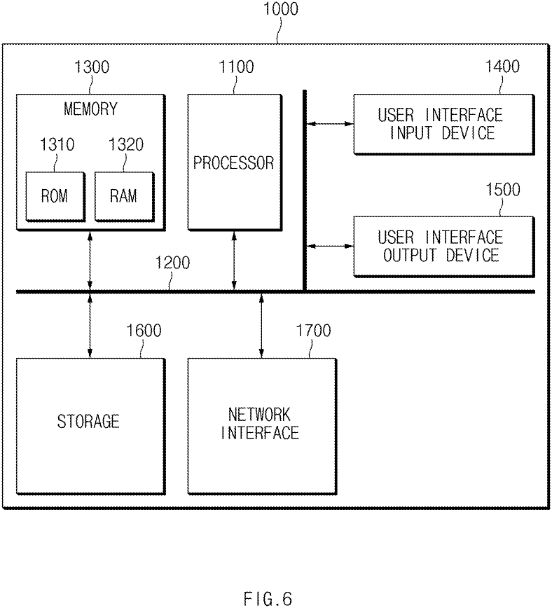

FIG. 6 is a diagram illustrating a computing system according to an embodiment of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The processor 1100 may include the service operation controller 130 that performs the connected service operation according to a service request processing result of the modem 110.

Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC) . The ASIC may be provided in a user terminal. Alternatively, the processor and storage medium may be implemented with separate components in the user terminal.

According to an embodiment of the present disclosure, by differently processing a call signal requesting a communication connection to the modem based on the connection state of the emergency call, the emergency call connection may be stably maintained.

According to an embodiment of the present disclosure, in a state in which an emergency call with high priority is connected, the call signal that attempts to communicate with a vehicle is blocked from the outside of the vehicle, thereby preventing a vehicle’s modem from consuming battery power unnecessarily, and thus stably maintaining the emergency call.

Besides, a variety of effects directly or indirectly understood through this disclosure may be provided.

The above description is merely illustrative of the technical idea of the present disclosure, and those of ordinary skill in the art to which the present disclosure pertains will be able to make various modifications and variations without departing from the essential characteristics of the present disclosure.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. A service request processing apparatus for a modem for a vehicle comprising:
a receiver configured to receive emergency call state information generated based on a connection state of an emergency call service of a vehicle, and a service request for attempting a communication connection to the vehicle from a sender;
a management device configured to update the emergency call state information in storage;
a service request processor configured to retrieve the emergency call state information in the storage in response to the service request, and to determine whether to transmit the service request to the vehicle based on the emergency call state information; and
a transmitter configured to transmit the service request to the vehicle under a control of the service request processor.

2. The service request processing apparatus of claim 1, wherein the transmitter transmits the service request to the modem in the vehicle, which connects the emergency call service.

3. The service request processing apparatus of claim 2, wherein the transmitter transmits a connected service request for attempting remote control of the vehicle as the service request.

4. The service request processing apparatus of claim 1, wherein the management device updates the emergency call state information to the storage by designating any one of an end state, an operation state, and a callback state.

5. The service request processing apparatus of claim 4, wherein the service request processor transmits the service request to the vehicle through the transmitter, based on whether the emergency call state information is the end state or the callback state.

6. The service request processing apparatus of claim 5, wherein the service request processor transmits, to the sender, information informing of refraining from requesting a service, based on the emergency call state information being the callback state.

7. The service request processing apparatus of claim 4, wherein the service request processor rejects the service request based on the emergency call state information being the operation state.

8. A service request processing method for a modem for a vehicle, the method comprising:
updating, by a management device, an emergency call state information generated based on a connection state of an emergency call service of the vehicle;
identifying, by a server, the emergency call state information in response to a service request for attempting a communication connection from a sender to the vehicle; and
determining, by a service request processor, whether to transmit the service request to the modem based on the emergency call state information.

9. The method of claim 8, wherein the identifying of the emergency call state information further includes identifying, by the server, whether the service request is a signal for calling the modem in the vehicle, which connects the emergency call service.

10. The method of claim 9, wherein the identifying of the emergency call state information further includes identifying, by the server, whether the service request is a connected service request for attempting remote control of the vehicle.

11. The method of claim 8, wherein the updating of the emergency call state information includes updating, by the management device, the emergency call state information by designating any one of an end state, an operation state, and a callback state.

12. The method of claim 11, wherein the determining of the whether to transmit the service request includes transmitting, by the service request processor, the service request to the vehicle, based on whether the emergency call state information is the end state or the callback state.

13. The method of claim 11, wherein the determining of the whether to transmit the service request includes transmitting, by the service request processor, to the sender, information informing of refraining from requesting a service, based on the emergency call state information being the callback state.

14. The method of claim 11, wherein the determining of the whether to transmit the service request includes rejecting, by the service request processor, a transmission of the service request based on the emergency call state information being the operation state.

15. A modem for a vehicle comprising:
a modem controller configured to generate emergency call state information based on a connection state of an emergency call;
a transmission interface configured to transmit the emergency call to an external emergency center and to transmit the emergency call state information to an external server; and
a reception interface configured to receive the emergency call and to receive a service request for the vehicle.

16. The modem for the vehicle of claim 15, wherein the reception interface receives a connected service request for attempting remote control of the vehicle as the service request.

17. The modem for the vehicle of claim 15, wherein the modem controller sets the emergency call state information in a state in which the emergency call is not transmitted to an end state.

18. The modem for the vehicle of claim 15, wherein the modem controller sets the emergency call state information of a state in which communication with the emergency center is connected to an operation state based on the transmission of the emergency call.

19. The modem for the vehicle of claim 15, wherein the modem controller sets the emergency call state information in a state in which the emergency call is sent within a specific time and communication with the emergency center is not connected to a callback state.

20. The modem for the vehicle of claim 15, wherein the modem controller further provides the service request received while the emergency call state information is in an end state or a callback state to a control device of the vehicle.
